(19) United States
(12) Patent Application Publication
(10) Pub. No.: US 2018/0146374 A1
(43) Pub. Date: May 24, 2018

(54) SYSTEM, METHODS AND SOFTWARE FOR USER AUTHENTICATION

(71) Applicants: MEIR GOLAN, GIVAT SHMUEL (IL); URIEL GOLAN, GIVAT SHMUEL (IL)

(72) Inventors: MEIR GOLAN, GIVAT SHMUEL (IL); URIEL GOLAN, GIVAT SHMUEL (IL)

(21) Appl. No.: 15/813,623

(22) Filed: Nov. 15, 2017

Related U.S. Application Data
(60) Provisional application No. 62/422,893, filed on Nov. 16, 2016.

(51) Int. Cl. H04W 12/06; H04L 29/06

(52) U.S. Cl. CPC H04W 12/06; H04L 63/068; G06Q 20/127; H04L 63/0861; H04L 63/0876; H04L 63/083

(57) ABSTRACT

A system and method for authenticated-user access, the system including an optical device proximal to an entrance adapted to capture a biometric credential of an individual user, a communication network adapted to receive from and send signals to the optical device, a portable communication device associated with the individual user, the portable communication device in connection with the network and a processor adapted to receive the biometric credential of the user and to match the biometric credential with a previous pre-authorized biometric credential, of the user and to send an authorization key to the portable communication device responsive to the match to provide the individual user with a time-limited access key to the entrance.

### CROSS-REFERENCE TO RELATED APPLICATIONS

This application claims the benefit of U.S. Provisional Patent Application No. 62/422,893, filed Nov. 16, 2016, the description of which is hereby incorporated by reference.

### FIELD

The present invention relates generally to methods and systems of user authentication, and more specifically to novel methods and systems for user authentication.

### BACKGROUND

Prior art authentication methods typically use either RFID or fixed barcodes for authentication. These may include personnel entry access systems, employee entry/exit time registration and the like.

US 20130167208 A1 discloses systems and methods for a user to use a mobile device such as a smart phone to scan a QR (Quick Response) code displayed on a login webpage of a website. The QR code may encode a server URL of the website. The mobile device decodes the QR code and transmits a device ID and other decoded information to a service provider. The service provider locates login credentials of the user linked to the device ID and communicates the login credentials to a website server for user authentication. Alternatively, the mobile device may transmit its device ID to the website server for the website server to locate a user account linked to the device ID for user login. Alternatively, the mobile device may transmit stored login credentials to the website server. Advantageously, a user may access a website without the need to provide any login credentials.

US 20130219479 discloses systems and methods for a user to use a trusted device to provide sensitive information to an identity provider via QR (Quick Response) code for the identity provider to broker a website login or to collect information for the website. A user may securely transact with the web site from unsecured devices by entering sensitive information into the trusted device. The identity provider may generate the QR code for display by the website on an unsecured device. A user running an application from the identity provider on the trusted device may scan the QR code to transmit the QR code to the identity provider. The identity provider may validate the QR code and may receive credential information to authenticate the user or may collect information for the website. Advantageously, the user may perform a safe login to the website from untrusted devices using the trusted device

There still remains a need for improved user authentication systems and methods.

### SUMMARY

It is an object of some aspects of the present invention to provide improved methods, software and systems for user authentication.

In some embodiments of the present invention, improved methods and systems are provided for user authentication using a digital link.

In other embodiments of the present invention, a method and system is described for providing improved authentication using a mobile device App.

The present invention further provides a system for authenticated-user access, the system including an optical device proximal to an entrance adapted to detect a displayed element, displayed on a portable communication device, associated with an individual user, a communication network adapted to receive from and send signals to the optical device, the portable communication device in connection with the network and a processor adapted to receive data associated with the displayed element from the optical device and to match data associated with at least one credential of the user and data associated with at least one credential of the portable communication device with at least one of a) a previous pre-authorized user credential and b) a previous pre-authorized portable communication device credential and to send an authorization key to the optical device responsive to the match to provide the individual user with a time-limited access key to the entrance.

The present invention also provides a system for authenticated-user access, the system including an optical device proximal to an entrance adapted to capture and/or detect a displayed element, displayed on a portable communication device, associated with an individual user, a communication network adapted to receive from and send signals to the optical device, the portable communication device in connection with the network and a processor adapted to receive data associated with the displayed element from the optical device and to match data associated with at least one credential of the user and data associated with at least one credential of the portable communication device with at least one of a) a previous pre-authorized user credential and b) a previous pre-authorized portable communication device credential and to send an authorization key to the portable communication device responsive to the match to provide the individual user with a time-limited access key to the entrance.

The present invention also provides a system and method for authenticated-user access, the system including an optical device proximal to an entrance adapted to capture and/or detect a displayed element, displayed on a portable communication device, associated with an individual user, a communication network adapted to receive from and send signals to the optical device, the portable communication device in connection with the network and a processor adapted to receive the displayed element from the optical device and to match data associated with at least one credential of the user and data associated with at least one of a) a credential of the portable communication device with at least one of a previous pre-authorized user credential and b) a previous pre-authorized portable communication device credential and to send an authorization key to the portable communication device responsive to the match to provide the individual user with a time-limited access key to the entrance.

There is thus provided according to an embodiment of the present invention, a computer software product, the product configured for authenticated-user access, the product comprising a computer-readable medium in which program instructions are stored, which instructions, when read by a computer, cause the computer to:
a. capture a digital link, displayed on a portable communication device, associated with an individual user;
b. detect signals from the portable communication device over a communication network;
c. match at least one of data associated with a user credential and data associated with a portable communication device with data in a database to provide an authorized match;
d. send an authorization key to at least one of the portable communication device and the optical device responsive to the authorized match to provide the individual user with a time-limited access key to the entrance; and
e. optionally sending a failed authorization message to the portable communication device upon a failed match.

The present invention further provides a system and method for authenticated-user access, the system including an optical device proximal to an entrance adapted to capture and/or detect a digital link, displayed on a portable communication device, associated with an individual user, a communication network adapted to receive from and send signals to the optical device, the portable communication device in connection with the network and a processor adapted to receive the digital link from the optical device and to match data associated with at least one credential of the user and data associated with at least one credential of the portable communication device with at least one of a previous pre-authorized user credential and a previous pre-authorized portable communication device credential and to send an authorization key to the portable communication device responsive to the match to provide the individual user with a time-limited access key to the entrance.

The present invention provides a system and method for authenticated-user access, the system including an optical device proximal to an entrance adapted to capture and/or detect a digital link, displayed on a portable communication device, associated with an individual user, a communication network adapted to receive from and send signals to the optical device, the portable communication device in connection with the network and a processor adapted to receive the digital link from the optical device and to match data associated with at least one credential of the user and data associated with at least one credential of the portable communication device with at least one of a previous pre-authorized user credential and a previous pre-authorized portable communication device credential and to send an entrance authorization key to the optical device responsive to the match to provide a time-limited access key to the entrance.

The present invention provides a system and method for authenticated-user access, the system including an optical device proximal to an entrance adapted to capture a digital link, from a portable communication device, associated with an individual user, a communication network adapted to receive from and send signals to the optical device, the portable communication device in connection with the network and a processor adapted to receive the digital link from the optical device and to match data associated with at least one credential of the user and data associated with at least one credential of the portable communication device with at least one of a previous pre-authorized image the fingerprint, the other biometric credential, the pincode, the password and the voice recognition pattern of the user and to send an authorization key to the portable communication device responsive to the match to provide the individual user with a time-limited access key to the entrance.

The present invention provides a system and method for authenticated-user access, the system including an optical device proximal to an entrance adapted to capture at least one of a real-time image fingerprint, other biometric credential, a pincode, a password and a voice recognition pattern of an individual user, a communication network adapted to receive from and send signals to the optical device, a portable communication device associated with the individual user, the portable communication device in connection with the network and a processor adapted to receive the at least one of the real-time image, the fingerprint, the other biometric credential, the pincode, the password and voice recognition pattern of the user and to match the at least one of the real-time image fingerprint, the other biometric credential, the pincode, the password and the voice recognition pattern of the individual with at least one of a previous pre-authorized image the fingerprint, the other biometric credential, the pincode, the password and the voice recognition pattern of the user and to send an authorization key to the portable communication device responsive to the match to provide the individual user with a time-limited access key to the entrance.

The present invention provides a system and method for authenticated-user access, the system including an optical device proximal to an entrance adapted to capture a digital link, from a portable communication device, associated with an individual user, a communication network adapted to receive from and send signals to the optical device, the portable communication device in connection with the network and a processor adapted to receive the digital link from the portable communication device and to match data associated with at least one credential of the user and data associated with at least one credential of the portable communication device with at least one of a previous pre-authorized image the fingerprint, time and date, the other biometric credential, the pincode, the password and the voice recognition pattern of the user and to send an authorization key to the portable communication device responsive to the match to provide the individual user with a time-limited access key to the entrance.

There is thus provided according to an embodiment of the present invention, a method for providing a double-side and double-step authentication for a user gaining entry to an entrance, the method comprising:
a) a mobile device authenticating and validating credentials of the user and of the mobile device;
b) uploading a digital link onto the mobile device;
c) optically detecting the digital link on the mobile device, and
d) authenticating and validating data associated with the digital link on the mobile device and/or other credentials before providing the user with time-limited access to the entrance.

The method thus comprises a two-step/double-step/double-side/two-side authentications are:
i. Mobile device—mobile device and/or Mobile device—server.
ii. Optical device—optical device and/or Optical device—server.

There is thus provided according to an embodiment of the present invention, a system for authenticated-user access, the system including;
a. an optical device proximal to an entrance adapted to capture at least one of a real-time image fingerprint, a digital link, time and date, other biometric credential, a pincode, a password and a voice recognition pattern of an individual user;
b. a communication network adapted to receive from and send signals to the optical device;
c. a portable communication device associated with the individual user, the portable communication device in connection with the network; and
d. a processor adapted to;
   i. receive the at least one of the real-time image fingerprint, the digital link, the other biometric credential, the time and the date, the pincode, the password and the voice recognition pattern of the individual and to compare with at least one of a previous pre-authorized image the fingerprint, the digital link, the other biometric credential, the pincode, the password and the voice recognition pattern of the user and to match at least one of the real-time image fingerprint, the digital link, the other biometric credential, the pincode, the password and the voice recognition pattern of the individual with at least one of a previous pre-authorized image the fingerprint, the digital link, the other biometric credential, the pincode, the password and the voice recognition pattern of the user;
   ii. send an authorization key to the portable communication device responsive to the match to provide the individual user with a time-limited access key to the entrance,
wherein the processor optionally sends a failed authorization message to the device upon a failed match.

Additionally, according to an embodiment of the present invention, the system further includes;
e. a payment device for charging the user for the time-limited access key to the entrance.
   Furthermore, according to an embodiment of the present invention, the system includes applying an external billing system for charging the user. The user may be charged for time-limited access key to the entrance, billing, ticketing or any other charge associated with the entry to the establishment/parking.

Moreover, according to an embodiment of the present invention, the system further includes;
f a ticketing device for providing the user with a ticket for the time-limited access key to the entrance.

Further, according to an embodiment of the present invention, the entrance is selected from an interior door, an exterior door, a person-access gate, a vehicle access gate, a person-access barrier, a virtual entrance, an amusement park and a vehicle access barrier.

Additionally, according to an embodiment of the present invention, the entrance is to a room, a building, a work place, a car park, a public site, a private site, a virtual site, a home, an academic institute, an airport, a train station, an amusement park or a shopping center.

Moreover, according to an embodiment of the present invention, the processor is on a remote server, in communication with the communication network.

Additionally or alternatively, the processor is on a local server, in communication with the communication network.

Additionally or alternatively, the processor is on the device, in communication with the communication network.

Moreover, according to an embodiment of the present invention, the server is adapted to authenticate both user credentials and device credentials.

Furthermore, according to an embodiment of the present invention the authorization key is a barcode, a digital key, a digital link and combinations thereof.

Moreover, according to an embodiment of the present invention, the optical device includes at least one of:
a) an external camera;
b) a slot disposed within the device and adapted to receive a mobile communication device; and
c) an internal camera disposed in at least one of an upper face and a lower face of the slot.

Furthermore, according to an embodiment of the present invention, the optical device includes at least one of a microphone, a speaker, a call button and a motion sensor.

Further, according to an embodiment of the present invention, the internal camera is operative to capture at least one of an image and a video of said mobile device or device screen, wherein the device screen displays at least one of a barcode, a digital key, a digital link and combinations thereof.

Moreover, according to an embodiment of the present invention, the optical device is adapted to capture an image of the barcode and/or digital link and to automatically open the entrance responsive to;
i. the barcode and/or the digital link providing data and/or information and/or credentials which matches data and/or information and/or credentials in a memory or database, such as in a server; and
ii. the optical device detecting the barcode and/or digital link within a time limit of the time-limited access.

Further, according to an embodiment of the present invention, the optical device is further adapted to capture at least one of an image of the user and an image of the mobile device if a deviation is detected in the (i) matching and (ii) detecting steps.

Moreover, according to an embodiment of the present invention, the authorization key is selected from a barcode, a digital link, an electronic signal, a digital signal and combinations thereof.

There is thus provided according to an embodiment of the present invention, a method for authenticated-user access, the method including;
a. capturing at least one a real-time image, fingerprint, other biometric credential, pincode, password and voice recognition of an individual user proximal to an entrance;
b. receiving signals from a portable communication device associated with the individual user over a communication network to an optical device proximal to the entrance;
c. matching the real-time image, fingerprint, other biometric credential, pincode, password and voice recognition of the user with a previous pre-authorized a real-time image, fingerprint, other biometric credential, pincode, password or voice recognition of the user;
d. sending an authorization key to the portable communication device responsive to the match to provide the individual user with a time-limited access key to the entrance; and
e. optionally sending a failed authorization message to the device upon a failed match.

Further, according to an embodiment of the present invention, the method further includes;
f. a payment device for charging the user for the time-limited access key to the entrance.

Moreover, according to an embodiment of the present invention, the entrance is selected from an interior door, an exterior door, a person-access gate, a vehicle access gate, a person-access barrier, and a vehicle access barrier.

Additionally, according to an embodiment of the present invention, the entrance is to a room, a building, a work place, a car park, a public site, a private site, a home, an academic institute, or a shopping center.

Moreover, according to an embodiment of the present invention, the matching step is performed by a processor on a remote server, in communication with the communication network.

Furthermore, according to an embodiment of the present invention, the method further includes authenticating both user credentials and device credentials.

Moreover, according to an embodiment of the present invention, the authorization key is a barcode.

Additionally, according to an embodiment of the present invention, the optical device captures an image of the barcode (and/or the digital link providing data and/or information and/or credentials) and to automatically open the entrance responsive to;
i. the barcode and/or the digital link providing data and/or information and/or credentials which matches data and/or information and/or credentials in a memory or database, such as in a server; and
ii. the optical device displaying the barcode within a time limit of the time-limited access.

Furthermore, according to an embodiment of the present invention, the method further includes capturing at least one image of the user if a deviation is detected in the (i) matching and (ii) displaying steps.

Moreover, according to an embodiment of the present invention, the authorization key is selected from a barcode, a digital link, an electronic signal, a digital signal and combinations thereof.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified pictorial illustration showing a system for user access control and authentication, in accordance with an embodiment of the present invention;

FIG. 1B is a simplified pictorial illustration showing a system for user access control, authentication and payment, in accordance with an embodiment of the present invention;

FIG. 1C is a simplified pictorial illustration showing details of the optical device (camera) shown in FIGS. 1A and 1B, in accordance with an embodiment of the present invention;

FIG. 1D is a simplified pictorial illustration showing details of the optical device (camera) shown in FIGS. 1A and 1B, in accordance with an embodiment of the present invention;

FIG. 2A is a simplified pictorial illustration showing a system for user access control and authentication, in accordance with an embodiment of the present invention;

FIG. 2B is a simplified pictorial illustration showing a system for user access control, authentication and payment, in accordance with an embodiment of the present invention;

FIG. 3A is a simplified pictorial illustration showing a system for user access control and authentication, in accordance with an embodiment of the present invention;

FIG. 3B is a simplified pictorial illustration showing a system for user access control, authentication and payment, in accordance with an embodiment of the present invention;

FIGS. 4A-4B is a simplified flow chart of a method for user access control, in accordance with an embodiment of the present invention;

FIG. 5 is a simplified flow chart of a method for user access control, in accordance with an embodiment of the present invention; and

FIGS. 6A-6B is a simplified flow chart of a method for user access control, in accordance with an embodiment of the present invention;

In all the figures similar reference numerals identify similar parts.

### DETAILED DESCRIPTION

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The present invention provides a system and method for authenticated-user access, the system including an optical device proximal to an entrance adapted to capture at least one of a real-time image, fingerprint, other biometric credential, pincode, password and voice recognition of an individual user, a communication network adapted to receive from and send signals to the optical device, a portable communication device associated with the individual user, the portable communication device in connection with the network and a processor adapted to receive the at least one of the real-time image fingerprint, a digital link, other biometric credential, pincode, password and voice recognition of the user and to match the at least one real-time image fingerprint, a digital link, other biometric credential, pincode, password and voice recognition with a previous pre-authorized image fingerprint, a digital link, other biometric credential, pincode, password and voice recognition of the user and to send an authorization key to the portable communication device responsive to the match to provide the individual user with a time-limited access key to the entrance.

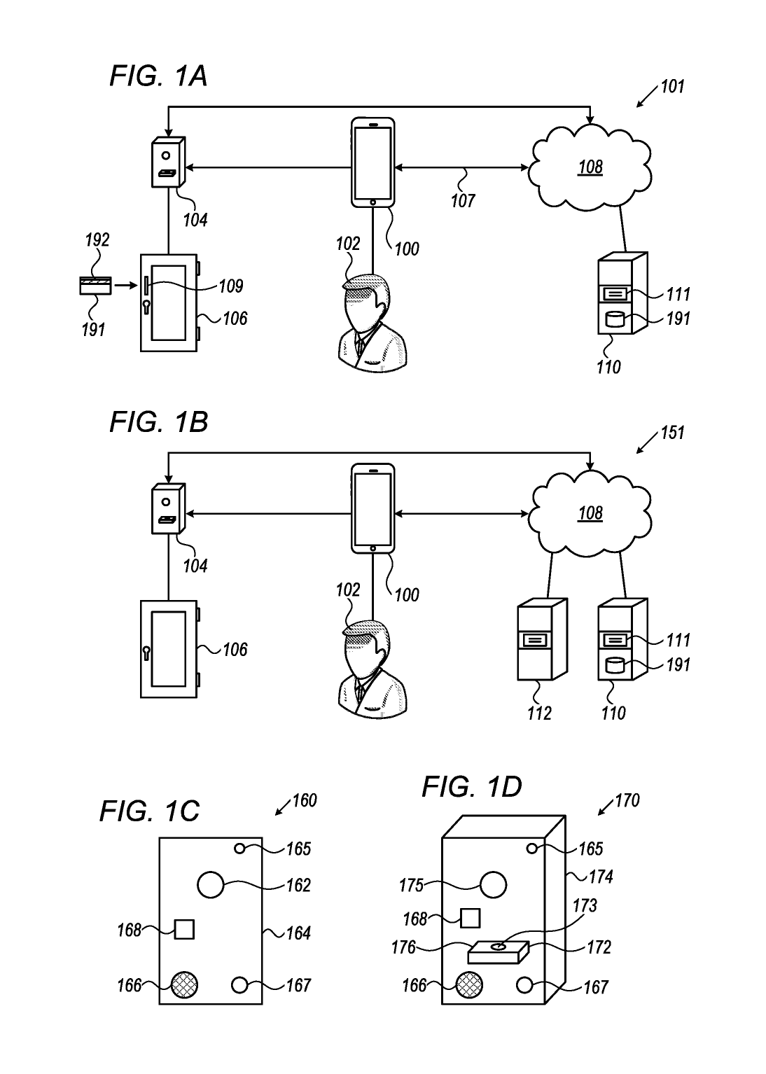

Reference is now made to FIG. 1A, which is a simplified pictorial illustration showing a system for user access control and authentication 101, in accordance with an embodiment of the present invention.

System 101 comprises at least one personal mobile communication device 100, selected from, but not limited to, the group consisting of a smartphone, a tablet, a smart watch, a dedicated mobile device and any other portable electronic device. The device is normally carried and/or used by a person, such as user 102.

Mobile device 100, may be for example, but is not limited to, an Apple iPhone 5s, Apple iPhone 6, Apple iPhone 6S, Apple iPhone 6 Plus, Apple iPhone 6S Plus, Apple iPhone 7, Apple iPhone 7 Plus, Apple iPhone 8, Apple iPhone 8 Plus, Apple iPhone X, Samsung Galaxy S6, Samsung Galaxy S7, Samsung Galaxy S8, Samsung Galaxy S8 Plus, Samsung Galaxy Note 8, LG G6, Google Pixel, Apple iPad, Samsung Galaxy Tab, Apple Watch and Samsung Gear S3.

The device is configured to communicate with at least one communication network 108, such as the internet.

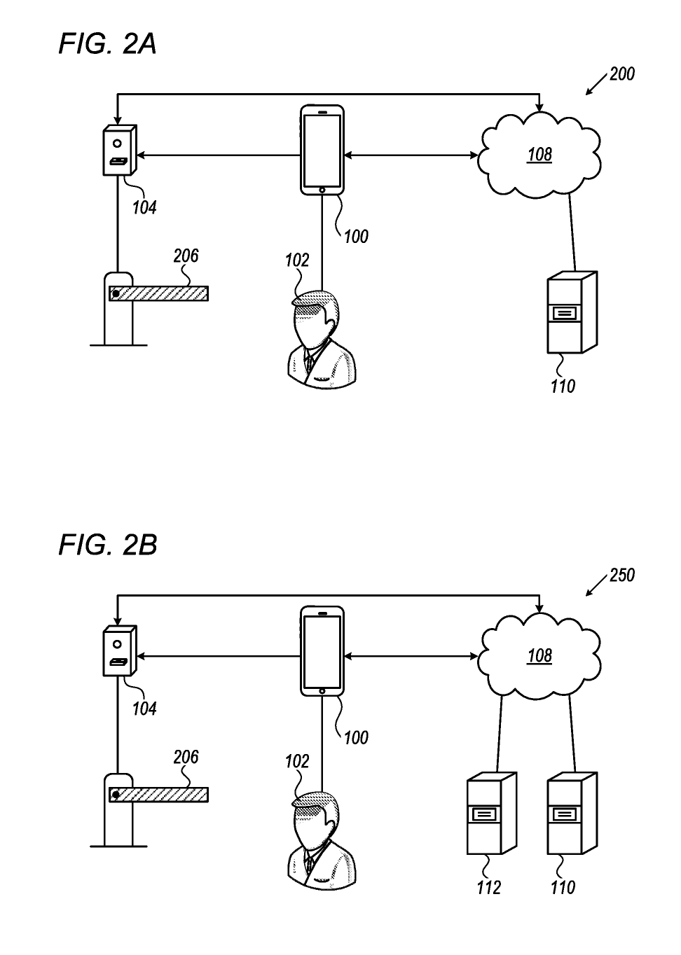

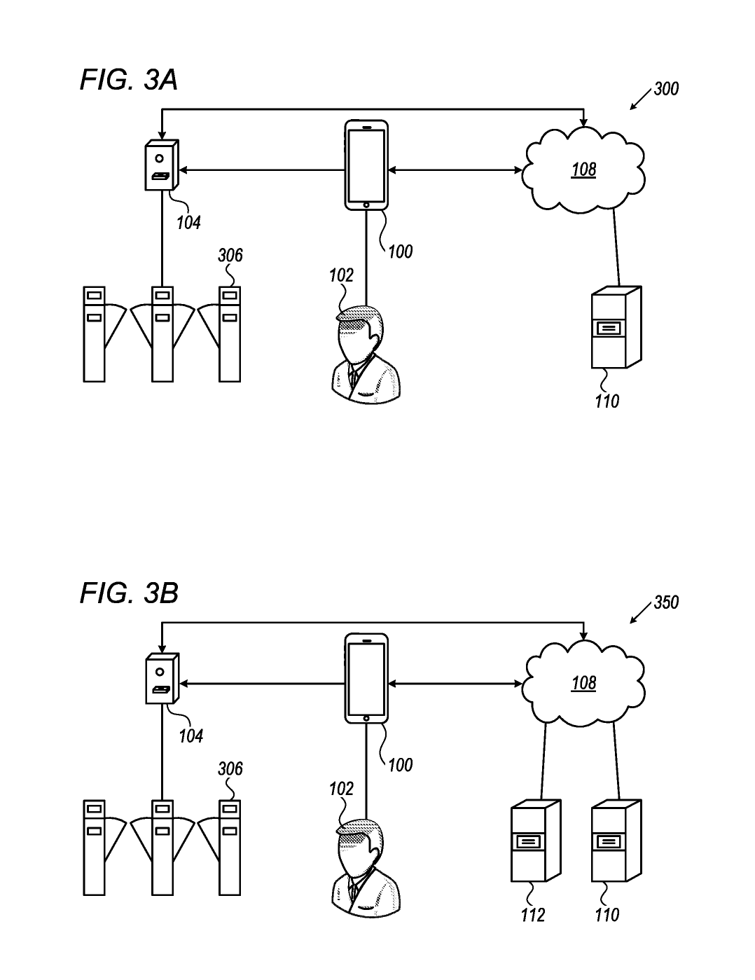

System 101 further comprises an optical device 104, disposed in proximity to an entrance 106, selected from, but not limited to, the group consisting of a door, a gate (306, FIG. 3A), a barrier (206, FIG. 2A), a port (not shown), an entry point (not shown), a virtual access point, a flap barrier gate, a tripod gate and any other access element. The optical device is configured to communicate with the at least one communication network 108.

The optical device 104 is described in further detail with reference to FIGS. 1C and 1D (either option may be used in all of the embodiments of the present invention). The optical device typically comprises a fixed smart reader with a camera, a processor, communication capabilities,. The smart reader can be placed next/on the access point (in this case a door. Can also be a part of a computer and/or software and/or mobile device).

System 101 typically comprises a server 110 with database/s 191 and/or a server connected to database/s, stored in the network 108.

System 101 typically includes a server utility 110, which may include one or a plurality of servers and one or more control computer terminals (not shown) for programming, trouble-shooting servicing, backup and other functions. Server utility 110 includes a system engine 111 and database, 191. Database 191 comprises a user profile and credentials database 121, a device and device credentials database 122 and a reader database 123.

Users, 102 may communicate with server 110 through a plurality of user computers (not shown 126, 127), which may be mainframe computers with terminals that permit individual to access a network, personal computers, portable computers, small hand-held computers and other, that are linked to the Internet 108. The Internet link of each of computers may be direct through a landline or a wireless line, or may be indirect, for example through an intranet that is linked through an appropriate server to the Internet. System 101 may also operate through communication protocols between computers over the Internet which technique is known to a person versed in the art and will not be elaborated herein.

Users may also communicate within the system through portable communication devices such as mobile phones 100, communicating with the Internet through a corresponding communication system (e.g. cellular system) connectable to the Internet through another link (107). As will readily be appreciated, this is a very simplified description, although the details should be clear to the artisan. Also, it should be noted that the invention is not limited to the user-associated communication devices—computers and portable and mobile communication devices—and a variety of others such as an interactive television system may also be used.

The system 101 also typically includes at least one call and/or user support center (not shown). The service center typically provides both on-line and off-line services to users. The server system 110 is configured according to the invention to carry out the methods of the present invention described herein.

It should be understood that many variations to system 101 are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet. Future devices for communications via new communication networks are also deemed to be part of system 101. Memories may be on a physical server and/or in a virtual cloud.

A mobile computing device may also embody a non-synced or offline copy of memories, copies of pathway cloud data, user profiles database, drug profiles database and execute the system, engine locally.

Depending on the capabilities of a mobile device, system 101 may also be incorporated on a mobile device that synchronizes data with a cloud-based platform.

The door 106 may optionally comprise a lock 109 for receiving a magnetic card 191 with a magnetic strip 192, such as, but not limited to a hotel room.

The optical device, upon authentication of a user, such as a guest in a hotel room, may pass a signal to the lock 109 to open the door. For example, the guest may not require to check in at the hotel lobby, but would rather receive a notification to his/her mobile device with the details of his/her room and an authorization code and/or digital link and/or access key, which will activate the optical device to open the door lock.

Additionally or alternatively, the guest can send the access key to other mobile devices to other guests in the same room, in accordance with the number of people booked to that room.

Reference is now made to FIG. 1B, which is another simplified pictorial illustration showing a system for user access control, authentication and payment 151, in accordance with an embodiment of the present invention.

System 151 comprises at least one personal mobile communication device 100, selected from, but not limited to, the group consisting of a smartphone, a tablet, a smart watch, a dedicated mobile device and any other portable electronic device. The device is normally carried and/or used by a person, such as user 102.

The device is configured to communicate with at least one communication network 108, such as the internet.

System 151 further comprises an optical device 104, disposed in proximity to an entrance 106, selected from, but not limited to, the group consisting of a door, a gate (306, FIG. 3A), a barrier (206, FIG. 2A), a port (not shown), an entry point (not shown), a virtual access point and any other access element. The optical device is configured to communicate with the at least one communication network 108.

The optical device 104 is described in further detail with reference to FIG. 1C and 1D (either option may be used in all of the embodiments of the present invention). The optical device typically comprises a fixed smart reader with a camera, a processor, communication capabilities. The smart reader can be placed next/on the access point (in this case a door. Can also be a part of a computer and/or software and/or mobile device).

System 151 further comprises a billing and/or ticketing apparatus 112, for billing the user for gaining entrance, for providing a parking ticket, cinema ticket, rail ticket, underground ticket or any entrance ticket, as is known in the art. The billing and/or ticketing apparatus 112 is connected via the internet 108 to the mobile device.

Additionally or alternatively, the billing and/or ticketing apparatus may be provided by a third party.

System 151 typically comprises a server 110 with database/s 191 and/or a server connected to database/s, stored in the network 108.

System 151 typically includes a server utility 110, which may include one or a plurality of servers and one or more control computer terminals (not shown) for programming, trouble-shooting servicing, backup and/and any other functions. Server utility 110 includes a system engine 111 and database, 191. Database 191 comprises a user profile database 121, a device database 122 and a reader database 123 and an event log database 124 (not shown).

Reference is now made to FIG. 1C, which is a simplified pictorial illustration showing details of the optical device 160 shown in FIGS. 1A and 1B (missing), authentication and payment, in accordance with an embodiment of the present invention.

According to one embodiment, the optical device 104 is a physical smart hardware device 164 including a camera 162.

Camera 162, may be for example, but is not limited to a Sony Exmor model number RS IMX230 or an OmniVision model no. OV5640.

The optical device 104 may optionally include at least one of a microphone 165, a speaker 166, a call button 167 and a motion or proximity sensor 168. The motion sensor may be, for example, but is not limited to a PIR (motion) sensor. The device's hardware also includes processor and/or different kinds of memory hardware and/or different kinds of communication models etc.

The optical device may further comprise an infrared sensor (169, not shown). The optical device may further comprise night vision sensor element and heat sensors (not shown). The hardware runs an Operating System and/or any other kind of software.

According to another embodiment, the optical device 104 comprises a camera 102. The camera connected to the physical smart hardware device 164). The camera is located on the device's surface facing out.

FIG. 1D is a simplified pictorial illustration showing details of the optical device (camera) 170 shown in FIGS. 1A and 1B, in accordance with an embodiment of the present invention. These drawing should not be deemed limiting, they provide embodiments relating to mobile devices, such as smart phones. In computer mobile devices, these optical devices may be of a different form.

According to another embodiment, optical device 170 comprises a physical smart hardware device 174 including some sort of an optional exterior camera 175. The device' s hardware also includes processor and/or different kinds of memory hardware and/or different kinds of communication models etc. The hardware runs an Operating System and/or any other kind of software. The device may optionally include a microphone 165, a speaker 166 and a call button 167.

The optical device 170 may optionally include at least one of a microphone 165, a speaker 166, a call button 167 and a motion sensor 168 (these having typical functions known in the art. These may also connect to the portable communication device and to the server via the communication network).

The device further comprises a deep slot or recess 172 large enough to hold or comprise different kinds of mobile devices. Inside the slot there is a camera 173 located on an upper inner face 176 of the slot, such as, facing down. Additionally or alternatively, there is a second camera 177 (not shown) on a lower face 178 (not seen) of the slot.

Reference is now made to FIG. 2A, which is a simplified pictorial illustration showing a system for user access control and authentication 200, in accordance with an embodiment of the present invention.

System 200 comprises at least one personal mobile communication device 100, selected from, but not limited to, the group consisting of a smartphone, a tablet, a smart watch, a dedicated mobile device and any other portable electronic device. The device is normally carried and/or used by a person, such as user 102.

The device is configured to communicate with at least one communication network 108, such as the internet.

System 200 further comprises an optical device 104, disposed in proximity to an entrance 206, selected from, but not limited to, the group consisting of a door, a gate (306, FIG. 3A), a barrier (206, FIG. 2A), a port (not shown), an entry point (not shown), a virtual access point and any other access element. The optical device is configured to communicate with the at least one communication network 108.

The optical device 104 is described in further detail with reference to FIG. 1C. The optical device typically comprises a fixed smart reader with a camera, a processor, communication capabilities, The smart reader can be placed next/on the access point (in this case a door). The smart reader may alternatively be a part of a computer and/or software and/or mobile device).

System 200 typically comprises a server 110 with database/s 191 and/or a server connected to database/s, stored in the network 108.

Reference is now made to FIG. 2B, which is a simplified pictorial illustration showing a system for user access control, authentication and payment 250, in accordance with an embodiment of the present invention.

System 250 comprises at least one personal mobile communication device 100, selected from, but not limited to, the group consisting of a smartphone, a tablet, a smart watch, a dedicated mobile device and any other portable electronic device. The device is normally carried and/or used by a person, such as user 102.

The device is configured to communicate with at least one communication network 108, such as the internet.

System 250 further comprises an optical device 104, disposed in proximity to an entrance 206, selected from, but not limited to, the group consisting of a door, a gate (306, FIG. 3A), a barrier (206, FIG. 2A), a port (not shown), an entry point (not shown), a virtual access point and any other access element. The optical device is configured to communicate with the at least one communication network 108.

The optical device 104 is described in further detail with reference to FIG. 1C. The optical device typically comprises a fixed smart reader with a camera, a processor, communication capabilities. The smart reader can be placed next/on the access point (in this case a door. Can also be a part of a computer and/or software and/or mobile device).

System 250 further comprises a billing and/or ticketing apparatus 112, for billing the user for gaining entrance, for providing a parking ticket or an entrance ticket, as is known in the art. The billing and/or ticketing apparatus 112 is connected via the internet 108 to the mobile device.

System 250 typically comprises a server 110 with database/s 191 and/or a server connected to database/s, stored in the network 108.

System 250 typically includes a server utility 110, which may include one or a plurality of servers and one or more control computer terminals (not shown) for programming, trouble-shooting servicing and other functions. Server utility 110 includes a system engine 111 and database, 191. Database 191 comprises a user profile database 121, a device database 122 and a reader database 123.

FIG. 3A is a simplified pictorial illustration showing a system for user access control and authentication, in accordance with an embodiment of the present invention;

System 300 comprises at least one personal mobile communication device 100, selected from, but not limited to, the group consisting of a smartphone, a tablet, a smart watch, a dedicated mobile device and any other portable electronic device. The device is normally carried and/or used by a person, such as user 102.

The device is configured to communicate with at least one communication network 108, such as the internet.

System 300 further comprises an optical device 104, disposed in proximity to an entrance 306, selected from, but not limited to, the group consisting of a door, a gate (306, FIG. 3A), a barrier (306, FIG. 2A), a port (not shown), an entry point (not shown), a virtual access point and any other access element. The optical device is configured to communicate with the at least one communication network 108.

The optical device 104 is described in further detail with reference to FIG. 1C. The optical device typically comprises a fixed smart reader with a camera, a processor, communication capabilities, The smart reader can be placed next/on the access point (in this case a door. It can also be a part of a computer and/or software and/or mobile device).

System 300 typically comprises a server 110 with database/s 191 and/or a server connected to database/s, stored in the network 108.

Reference is now made to FIG. 3B, which is a simplified pictorial illustration showing a system for user access control 350, authentication and payment, in accordance with an embodiment of the present invention;

System 350 comprises at least one personal mobile communication device 100, selected from, but not limited to, the group consisting of a smartphone, a tablet, a smart watch, a dedicated mobile device and any other portable electronic device. The device is normally carried and/or used by a person, such as user 102.

The device is configured to communicate with at least one communication network 108, such as the internet.

System 350 further comprises an optical device 104, disposed in proximity to an entrance 306, selected from, but not limited to, the group consisting of a door, a gate (306, FIG. 3A), a barrier (306, FIG. 2A), a port (not shown), an entry point (not shown), a virtual access point and any other access element. The optical device is configured to communicate with the at least one communication network 108.

The optical device 104 is described in further detail with reference to FIG. 1C. The optical device typically comprises a fixed smart reader with a camera, a processor, communication capabilities. The smart reader can be placed next/on the access point (in this case a door. Can also be a part of a computer and/or software and/or mobile device).

System 350 further comprises a billing and/or ticketing apparatus 112, for billing the user for gaining entrance, for providing a parking ticket or an entrance ticket, as is known in the art. The billing and/or ticketing apparatus 112 is connected via the internet 108 to the mobile device.

System 350 typically comprises a server 110 with database/s 191 and/or a server connected to database/s, stored in the network 108.

System 350 typically includes a server utility 110, which may include one or a plurality of servers and one or more control computer terminals (not shown) for programming, trouble-shooting servicing and other functions. Server utility 110 includes a system engine 111 and database, 191. Database 191 comprises a user profile database 121, a device database 122 and a reader database 123.

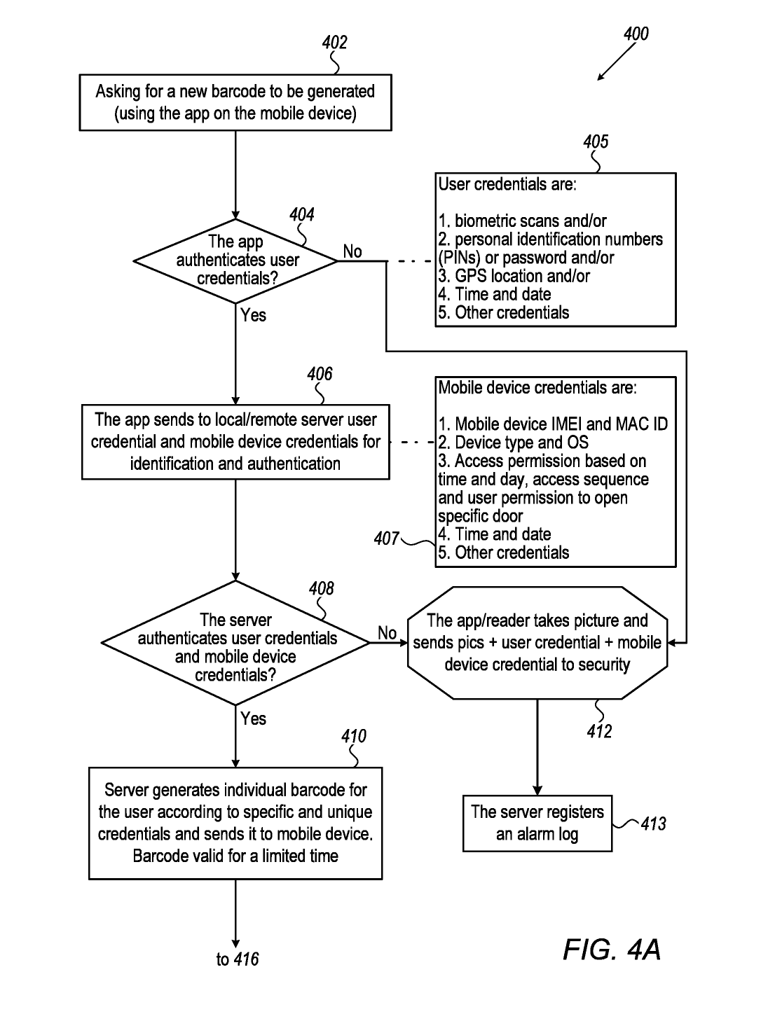

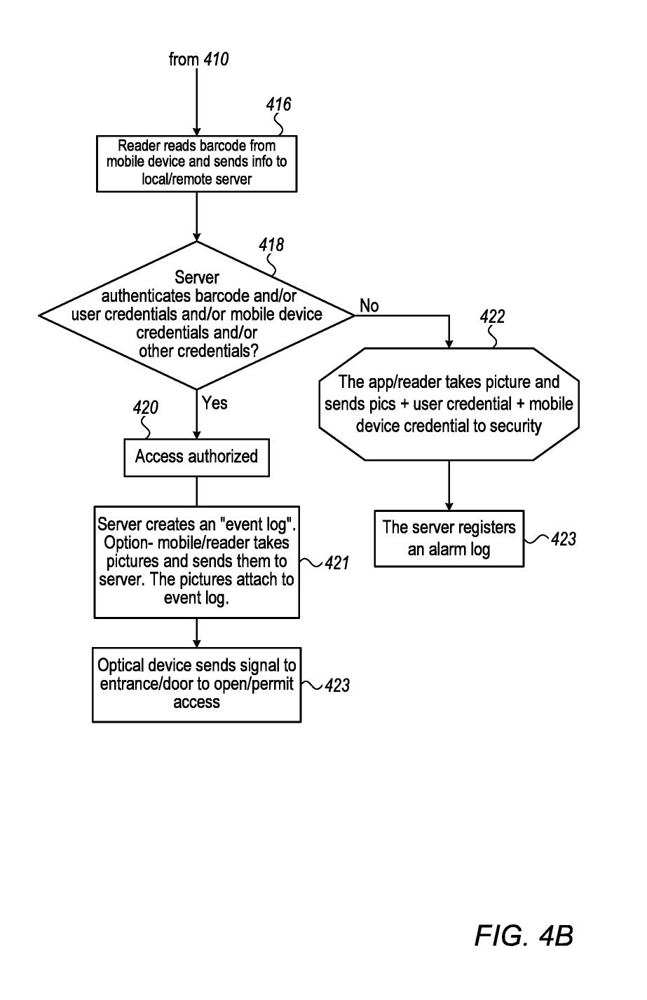

Reference is now made to FIGS. 4A-4B, which is a simplified flow chart 400 of a method for user access control, in accordance with an embodiment of the present invention.

In a barcode and/or digital link request step 402, a user 102 requests for a new barcode/digital link or other similar link means to be generated for him/her to gain access to an entry point 106. This step is typically performed using an App on device 100.

In a user authentication step 404, the AUDL system 101 (FIG. 1A) authenticates and authorized users, who are using one or more mobile devices 100.

The Authentication Using Digital Links (AUDL) (e.g., QR Codes, NFC, EZ Code™, MiniCode™ etc.) system generates a unique, one-time use Digital Link for use in the mobile device. Current prior art systems may use either RFID or fixed barcodes, with or without password and biometrical features. These systems are very easy to bypass, their security level is low, and the costs to secure each entrance are very high and can reach thousands of dollars).

In sharp contrast, the AUDL system 101 of the present invention, uses a designated App (199, not shown) on mobile device 100, which communicates to an authentication server, such as server 110 (FIG. 1A). Authentication occurs in 3 steps.

First, the user is authenticated with any or all of the following (shown in box 405): Biometric scanning, PIN or password, GPS location, time and date, network connections data, other unique credentials, in a user authentication step 404.

Secondly, device 100 is authenticated in a device checking step 406, using any or all of the following: mobile device IMEI and/or MAC ADDRESS, device type, model and OS, mobile device connectivity to a specific secured WIFI network, and access permission based on time and date, access sequence and user permission for a specific reader. The checking step may further include checking at least one of a time and a date and/or other credentials (shown in box 407).

The server verifies/authenticates both user 102 credentials and device 100 credentials in a user and device credential checking step 408.

If any of the above steps fail, at least one of the mobile device and the optical device/reader take photos of the user in a security checking step 412 and sends the photos and other authentication data and/or information to a designated security system and/or mobile device and/or elsewhere to optionally provide a real-time alert.

In an alarm log generating step 413, the server is operative to register an alarm log. It may send an alarm to an internal and/or external security system or security provision service.

If the above steps 402-408 succeed, then the app sends a request to a local/remote server 112 over a secured network or internet connection 108, a unique, one-time use Digital Link, or barcode, valid for limited time, in a digital link or barcode generating step 410. The time-limited digital link or barcode is then sent to the user's device 100 in this step.

The user then brings his device 100 into proximity with the optical device 104, which optically detects the time-limited digital link or barcode. The optical device reads the barcode/digital link/other in a time-limited digital link or barcode (or other) detecting step 416, which is sent to a local or remote server 110.

In a time-limited digital link or barcode authentication step 418, the server is operative to authenticate at least one of the user credentials and the mobile device credentials and/or other information and/or other data.

If the above credentials or barcode are authenticated in step 418, the user is given access to entry 106, such as, but not limited to by electronically releasing an electronic lock, lifting a barrier, removing a barrier, providing a virtual entry and the like in an access provision step 420, which is then authenticated using this digital link/barcode/other.

Thereafter, the server creates an “event log” and may optionally take pictures/videos of the user, in an event log creating step 421. In an alarm log generating step 424, the server is operative to register an alarm log. It may send an alarm to an internal and/or external security system or security provision service.

The optical device then sends an electrical signal, for example, to the entrance/door to open the door, permit access to the user etc. in a permitting user access step 423.

If the time limit has passed and/or the authentication fails in step 418, the App on device 100 and/or optical device 104 is/are operative to capture images and/or videos of the user and/or his/her surroundings and to alert security with a real-time alert in a security taking step 422.

Applications of the AUDL system include access control, point of sale payments, event admission, public transportation payment, any device or software which requires login or authentication credentials, access to any restricted event or location and the like.

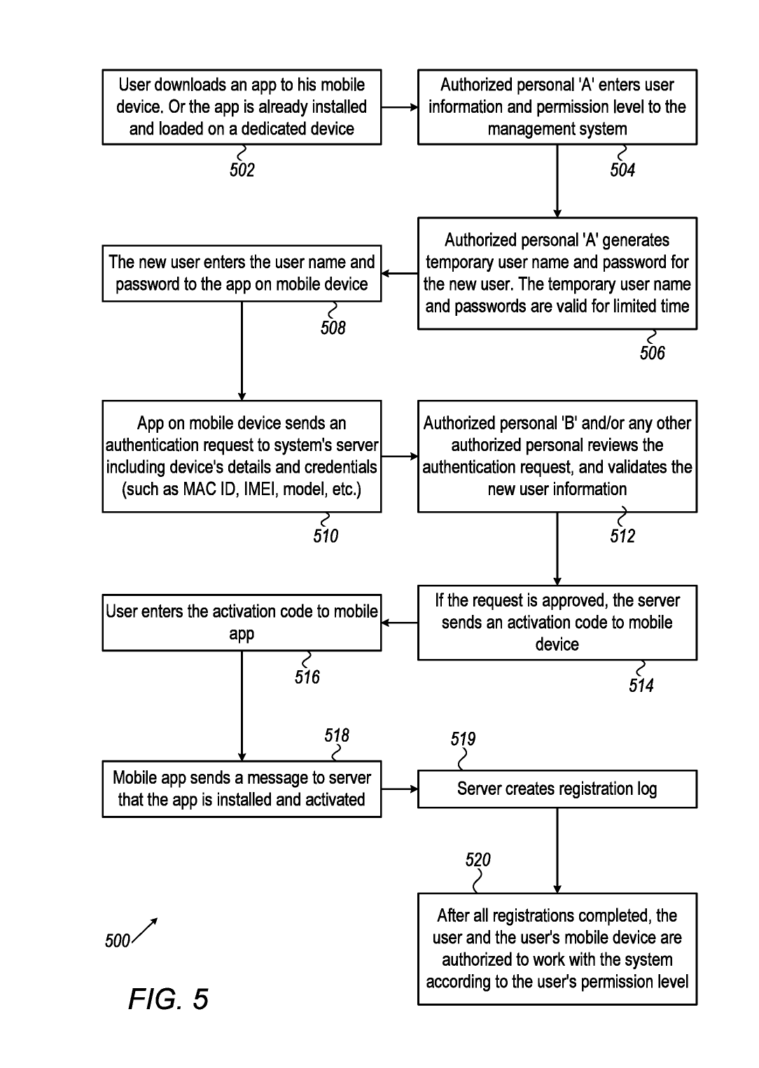

Reference is now made to FIG. 5 is a simplified flow chart of a method for user access control and registering and authorizing new users and mobile devices, 500, in accordance with an embodiment of the present invention.

In a downloading step 502, a user 102 downloads and installs an app to his/her mobile device 100 (or, optionally, the app is already installed and loaded on the dedicated device).

In an information entering step 504, an authorized personnel ‘A’ enters the user information and permission level to the management system (such as in system 101, FIG. 1A).

In a temporary user name and password generation step 506, the authorized personnel ‘A’ generate temporary user-name and password for the new user. The temporary user name and passwords are valid for limited time.

In an entering name and password step 508, the new user enters the user-name and password to the app on the mobile device 100.

In an authentication request step 510, the App on the mobile device sends an authentication request to the system's server 110, including the device's details and credentials (such as MAC ADDRESS, IMEI, model, etc.).

In a validating the authentication request step 512, an authorized personnel ‘B’ and/or any other authorized personal reviews the authentication request, and validates the new user information.

If the request is approved, the server sends an activation code to the mobile device in an activating code provision step 514.

Thereafter, the user enters the activation code to the mobile app on his/her device in an activation code entry step 516.

In a sending message step 518, the mobile app is operative to send a message to the server that the app has been installed and activated on the user's device 100. The mobile device is also operative, if required, to obtain at least one biometric credential from the user, such as a finger print, a voice recognition, an image, or additionally or alternatively a personalized message, a password, a pin number or the like. The mobile device may transfer some or all these credentials to the server.

The server then creates a registration log, in a registration log step 519.

Additionally or alternatively, the mobile device may gather further personal information and/or credentials of the user, such as ID number, date of birth, Facebook, social media data, email address and any other relevant data associated with the user and may send some/all of this data to the server.

After all registrations completed, the user and the user's mobile device are authorized to work with the system, in accordance with the user's permission level, in a device authorization step 520.

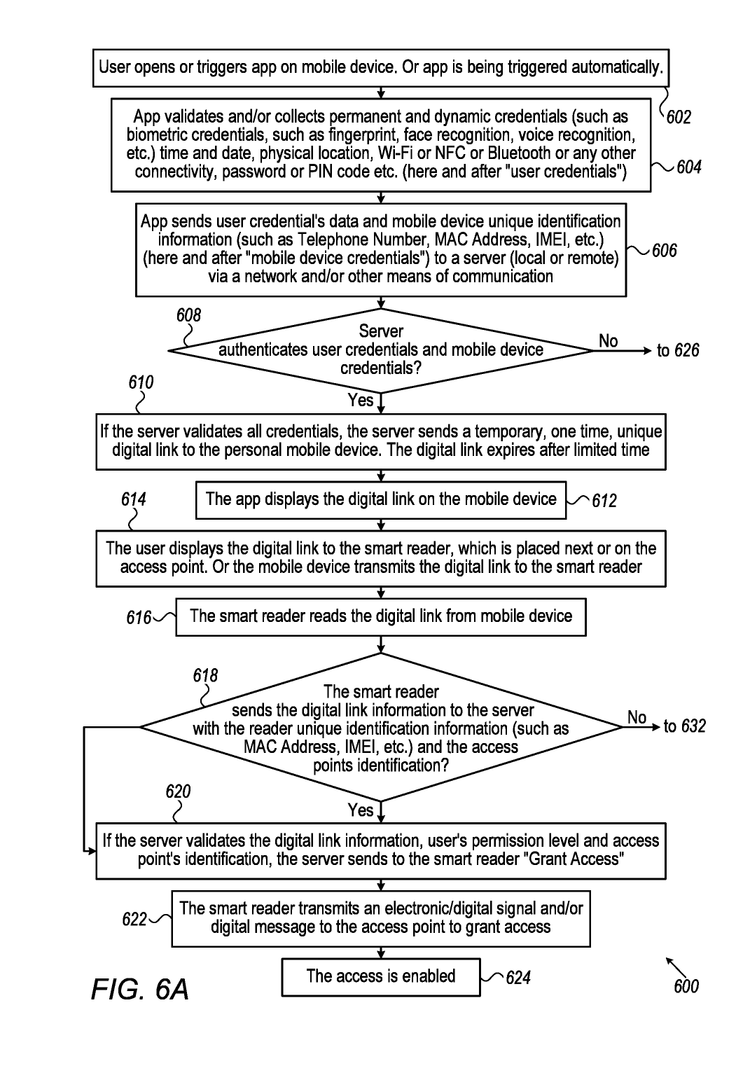

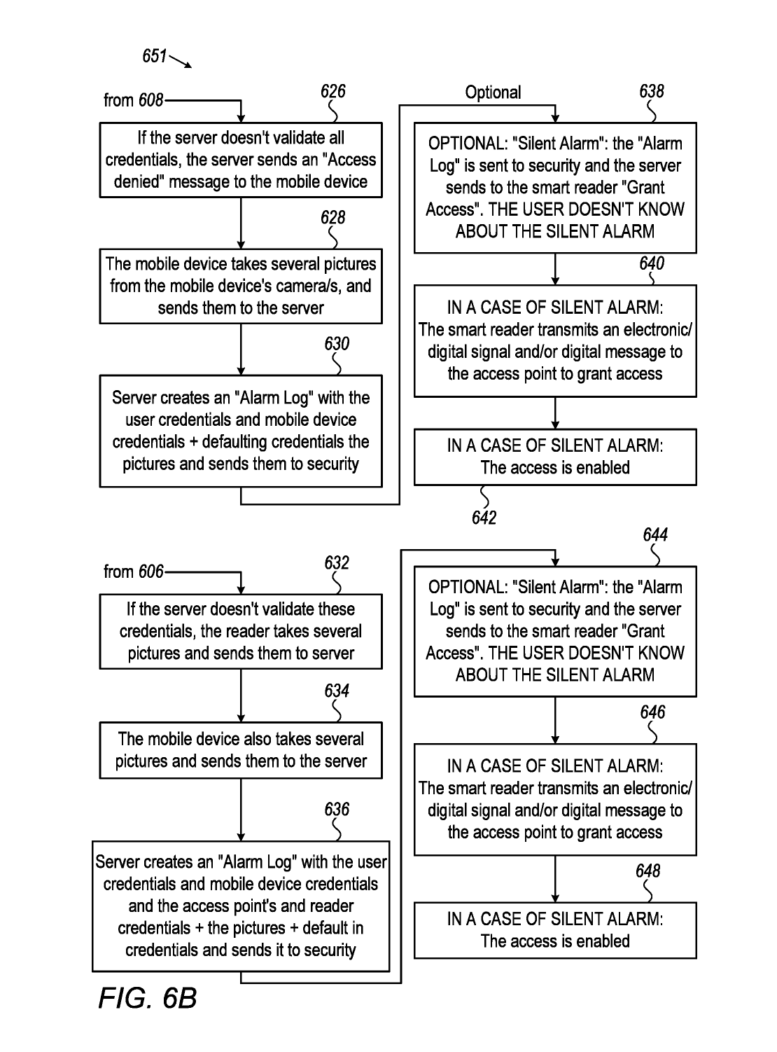

Reference is now made to FIGS. 6A-6B, which is a simplified flow chart of a method for user access control 600, in accordance with an embodiment of the present invention;

In an App triggering step 602, a user opens or triggers app on mobile device. Or app is being triggered automatically (for example by NFC, bluetooth, WI-FI, any software, etc.).

In an App user validation 604, the App is operative to validate and/or collect permanent and dynamic credentials (such as biometric credentials, such as fingerprint, face recognition, voice recognition, etc.) time and date, physical location, WI-FI or NFC or bluetooth or any other connectivity, password or pin code etc. (here and after “user credentials”).

In an App credential transmission step 606, the App sends user credentials' data and mobile device unique identification information (such as telephone number, MAC address, IMEi, etc., here and after “mobile device credentials”) to a server (local or remote, such as server 110 FIG. 1A) via a network 108 and/or other means of communication.

In a user and device credential authentication step 608, the server authenticates user 102 credentials and mobile device 100 credentials.

If the server does not validate all credentials, the server sends an “access denied” message to the mobile device, in an access denied message send step 626.

The mobile device takes several pictures from the mobile device's camera/s, in an image capturing step 628 and sends them to the server.

In an alarm log transmission step 630, the server is operative to create an “alarm log” with the user credentials and mobile device credentials +the pictures and sends it to security via the management system to provide a real-time alert and/or management app on a mobile device and/or website and/or e-mail and/or SMS and/or MMS and/or voice-call and/or voice-message and/or any other communication systems.

If the outcome of step 608 is “yes”, then in a one-time digital link transmission step 610, if the server validates all credentials, the server sends a temporary, one-time, unique digital link to the personal mobile device. The digital link expires after limited time.

In a digital link displaying step 612, the app displays the digital link on the mobile device.

Thereafter, the user displays the digital link in a displaying digital link step, 614, to the smart reader on the optical device, such as device 104, which is placed next or on the access point. Additionally or alternatively, the mobile device may be operative to transmit the digital link to the smart reader.

In a digital link reading step 616, the smart reader reads the digital link from mobile device.

Subsequently, the smart reader is operative to send the digital link information to the server, in a digital link sending step 618, with the reader unique identification information (such as MAC address, IMEI, etc.), together with the access point's identification data.

If the server validates the digital link information in a validating data step 620, the data including, but not limited to the digital link information, the user's permission level and access point's identification, then the server is operative to send a “grant access code” to the smart reader.

Thereafter in a providing access to the user step 622, the smart reader transmits an electronic/digital signal and/or digital message to the access point to grant access to the user.

The access is then enabled for a limited time period in an enabling access step 624.

Turning back to step 618, if the server does not validate all credentials, the mobile device takes several pictures from the mobile device's camera/s, in an image capturing step 632 and sends them to the server in a sending images step 634.

In an alarm log creating step 636, the server is operative to create an “alarm log” with the user credentials and mobile device credentials+the pictures and sends it to security via the management system to provide a real-time alert and/or management app on a mobile device and/or website and/or e-mail and/or SMS and/or MIMS and/or voice-call and/or voice-message and/or any other communication systems.

Turning back to step 630, optionally, if the server does not validate the digital link information, user's permission level and access point's identification the server sends an optional “silent alarm” in a silent alarm activation step 6638. The “alarm log” is sent to security and the server sends a “grant access to the optical device (also termed smart reader ” herein). Typically, the user does not know about the silent alarm.

In a case of silent alarm, the smart reader transmits an electronic/digital signal and/or digital message to the access point to grant access in a granting access step 640.

In a case of a silent alarm, the access is enabled and the user enters through the entrance in a user accessing step 642.

The server may further optionally creates an “alarm log” with the user credentials and mobile device credentials and the access point's and reader credentials and the pictures and default in credentials and sends them to security via the management system, optionally to provide a real-time alert and/or management app on a mobile device and/or website and/or e-mail and/or SMS and/or MMS and/or voice-call and/or voice-message and/or any other communication systems.

Turning back to step 636, if the server does not validate the digital link information, user's permission level and access point's identification the server sends an optional “silent alarm” in a silent alarm activation step 644. The “alarm log” is sent to security and the server sends a “grant access to the optical device (also termed smart reader ” herein). Typically, the user does not know about the silent alarm.

In a case of silent alarm, the smart reader transmits an electronic/digital signal and/or digital message to the access point to grant access in a granting access step 646.

In a case of a silent alarm, the access is enabled and the user enters through the entrance in a user accessing step 648.

Additionally or alternatively during a silent alarm, the mobile device also takes several pictures and sends them to server. The server may also create an optional alarm. Often, the “silent alarm” or the “alarm log” is sent to security (to provide a real-time alert) and the server sends a valid digital link to the mobile device.

According to some embodiments, every event in the methods of the present invention is recorded in an event log. The event log may be located on the server and/or in a virtual cloud.

Major and Main Differences Between the Present Invention and “Prior Art” Login Using QR Code”

In the prior art process, the trusted device also scans the barcode and also later provides additional information for (website) authentication. In sharp contrast, in the present invention, first, the barcode is generated according to specific information which the trusted device (such as device 100 in the drawings) provides, and then the trusted device displays the barcode. The barcode is able to be scanned from a reasonable distance by the other side (such as via the optical device 104 in FIG. 1A).

In their process, the barcode is being generated without any additional information inside (but timestamp).

Basically, the prior art process just connects between the two devices, whereas in the present invention method, additional information is added into the barcode (except for the Timestamp). This results in improved secured authentication systems, methods and software, as disclosed herein.

In the methods of the present invention, the same trusted device provides both the information (for the servers), as well as displaying the barcode and/or digital code to the optical reader.

In the prior art processes, the device which provides the information (for the servers) is the one to scan the QR code, while the other side displays it (opposite direction of the processes of the present invention).

In other embodiments of the present invention, the methods and systems of the present invention use temporary code (time-limited) and/or GPS-based code.

In other embodiments of the present invention, the methods and systems are configured to prevent forgery, hacking and identity theft.

The present invention systems and methods employ a double-side and double-step authentication. Firstly, the mobile device and/or server authenticates/validates the user credentials and the mobile device credentials. Secondly, when the optical device authenticates or validates the digital link's data and/or other credentials.

Thus, the two-step/double-step/double-side/two-side authentications are:

a) Mobile device—mobile device and/or Mobile device—server.

b) Optical device—optical device and/or Optical device—server.

Due to the use of rolling/temporary code (personalized for every user), and double authentication (mobile device authentication +optical reader authentication), the method of the present invention is configured to prevent forgery, hacking and identity theft.

The methods of the present invention require, according to some embodiments that no permanent authentication details of the user be stored on the mobile device.

The instant invention includes software and algorithms for user authentication, user access, user billing and user ticketing. Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Some embodiments may utilize client/server architecture, publisher/subscriber architecture, fully centralized architecture, partially centralized architecture, fully distributed architecture, partially distributed architecture, scalable Peer to Peer (P2P) architecture, or other suitable architectures or combinations thereof.

Some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk-Read-Only Memory (CD-ROM), Compact Disk-Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flow chart illustrations and/or block diagrams of methods, apparatus (systems) and computer program products according to embodiments of the invention. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow charts and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flow charts and/or block diagram block or blocks.

The flow charts and block diagrams in the Figures illustrate the architecture, functionality, and operation of possible implementations of systems, methods and computer program products according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustrations, and combinations of blocks in the block diagrams and/or flow chart illustrations, can be implemented by special purpose hardware-based systems that perform the specified functions or acts, or combinations of special purpose hardware and computer instructions.

Although the embodiments described above mainly address assessing test coverage of software code that subsequently executes on a suitable processor, the methods and systems described herein can also be used for assessing test coverage of firmware code. The firmware code may be written in any suitable language, such as in C. In the context of the present patent application and in the claims, such code is also regarded as a sort of software code.

It will be appreciated by persons skilled in the art that the present invention is not limited to what has been particularly shown and described hereinabove. Rather, the scope of the present invention is defined by the appended claims and includes both combinations and sub-combinations of the various features described hereinabove as well as variations and modifications thereof which would occur to persons skilled in the art upon reading the foregoing description. Accordingly, it is intended to embrace all such alternatives, modifications and variations that fall within the scope of the appended claims and all such claims that fall within the spirit of the invention.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

What is claimed is:

1. A system for authenticated-user access, the system comprising:
a. an optical device proximal to an entrance adapted to capture at least one of a real-time image fingerprint, a digital link, other biometric credential, a pincode, a password and a voice recognition pattern of an individual user;
b. a communication network adapted to receive from and send signals to said optical device;
c. a portable communication device associated with said individual user, said portable communication device in connection with said network; and
d. a processor adapted to:
i. receive said at least one of a real-time image fingerprint, said other biometric credential, said digital link, said pincode, said password and said voice recognition pattern, said at least one real-time image of said user, and at least one portable communication device credential and to match said at least one of a real-time image fingerprint, a digital link, said other biometric credential, said pincode, said password and said voice recognition pattern and said at least one real-time image with a previous pre-authorized at least one of a real-time image fingerprint, said other biometric credential, said digital link, said pincode, said password and said voice recognition pattern, said at least one real-time image of said user and said at least one portable communication device credential; and
ii. send an authorization key to said portable communication device responsive to said match to provide said individual user with a time-limited access key to said entrance,
wherein said processor is adapted to send a failed authorization message to said device upon a failed match.

2. A system according to claim 1, further comprising:
e. a payment device for charging said user for said time-limited access key to said entrance.

3. A system according to claim 1, wherein said entrance is selected from an interior door, an exterior door, a person-access gate, a virtual entrance, a vehicle access gate, a person-access barrier, and a vehicle access barrier.

4. A system according to claim 3, wherein said entrance is to a room, a building, a work place, a car park, a public site, a private site, a virtual access point, a home, an academic institute, or a shopping center.

5. A system according to claim 1, wherein said processor is on a remote server, in communication with said communication network.

6. A system according to claim 5, wherein said server is adapted to authenticate both user credentials and portable communication device credentials.

7. A system according to claim 6, wherein said authorization key is selected from is a barcode, a digital key, a digital link and combinations thereof.

8. A system according to claim 7, wherein said optical device is adapted to capture an image of said barcode or digital link and to automatically open said entrance responsive to:
i. the barcode and/or the digital link providing data and/or information and/or credentials which matches data and/or information and/or credentials in a memory or database, such as in a server; and
ii. the optical device detecting the barcode and/or digital link within a time limit of the time-limited access.

9. A system according to claim 8, wherein said optical device is further adapted to capture at least one image of said user if a match deviation is detected.

10. A system according to claim 3, wherein said authorization key is selected from a barcode, a digital link, an electronic signal, a digital signal and combinations thereof.

11. A method for authenticated-user access to an entrance, the method comprising:
a. detecting at least one of a user credential and a portable communication device credential;
b. matching at least one of data associated with a user credential and data associated with a portable communication device with data in a database to provide an authorized match;
c. sending a digital link or barcode to said portable communication device;
d. optically detecting signals or data associated with said digital link or barcode responsive to said authorized match;
e. providing a time-limited authorization key to said individual user with a time-limited access to said entrance; and
f. optionally sending a failed authorization message to said portable communication device upon a failed match.

12. A method according to claim 11, further comprising:
g. charging said user for said time-limited access key to said entrance.

13. A method according to claim 12, wherein said entrance is selected from an interior door, an exterior door, a person-access gate, a virtual entrance, a vehicle access gate, a person-access barrier, and a vehicle access barrier.

14. A method according to claim 13, wherein said entrance is to a room, a building, a work place, a car park, a public site, a private site, a virtual access point, a home, an academic institute, or a shopping center.

15. A method according to claim 14, wherein said matching step is performed by a processor on a remote server, in communication with said communication network.

16. A method according to claim 15, further comprising authenticating both user credentials and device credentials.

17. A method according to claim 16, wherein said authorization key is selected from is a barcode, a digital key, a digital link and combinations thereof.

18. A method according to claim 17, wherein said optically detecting step comprises capturing an image of said digital link or barcode.

19. A method according to claim 18, wherein said providing step is responsive to:
i. the barcode and/or the digital link providing data and/or information and/or credentials which matches data and/or information and/or credentials in a memory or database, such as in a server; and
ii. an optical device disposed proximal to said entrance displaying the barcode and/or digital link within a time limit of the time-limited access.

20. A method according to claim 19, further comprising capturing at least one image of said user if a deviation is detected in said (i) matching and (ii) displaying steps.
